(19) United States
(12) Patent Application Publication
(10) Pub. No.: US 2020/0205235 A1
(43) Pub. Date: Jun. 25, 2020

(54) WAX AND FRAGRANCE WARMING CUP

(71) Applicant: Aeron Lifestyle Technology, Inc., Fairfield, IA (US)

(72) Inventors: Lorene J. Anderson, Fairfield, IA (US); Jerome L. Clock, Hampton, IA (US)

(21) Appl. No.: 16/228,147

(22) Filed: Dec. 20, 2018

(51) Int. Cl. H05B 1/02

(52) U.S. Cl. CPC H05B 1/0269

(57) ABSTRACT

A wax warming cup for use in relation to a wax warming device has a bottom wall and a side wall that extends from the bottom wall to a top edge. The side wall has a transition point where the diameter of the side wall is the greatest. The top edge has at least a portion having a diameter less than the diameter of the transition point.

### BACKGROUND OF THE INVENTION

The present invention is directed to a cup for warming wax and other materials and more particularly to a wax warming cup that is easy to clean and prevents spills.

Cups for warming wax are known in the art and primarily are used to melt a fragrant cube of wax for the purpose of dispersing a fragrant scent. While useful, existing cups, based on their design, are susceptible to spills when transporting hot liquid wax. Also, current cups can be difficult to clean once the wax melts and removal of the wax can be challenging. Therefore a need exists in the art for a device that addresses these deficiencies.

An objective of the present invention is to provide a wax warming cup having a structure that better retains hot liquid wax.

Another objective is to provide a wax warming cup that is easy to clean and remove cooled wax.

These and other objectives will be apparent to those having ordinary skill in the art based upon the following written description, drawings and claims.

### SUMMARY OF THE INVENTION

A wax warming cup for use in relation to a wax warming device having a housing and a heating element. The wax warming cup has a bottom wall and a side wall that extends from the bottom wall to a top edge to form a chamber. The side wall has a transition point positioned where the side wall of the cup has its greatest diameter. At least a portion of the top edge has a diameter less than the diameter of the transition point.

The cup is made of a resilient material capable of being inverted with the application of manual force. The material is also capable of handling and transferring heat while remaining cool to the touch.

### BRIEF DESCRIPTION OF THE DRAWINGS

FIG. 1 is a side sectional view of a warming cup and a warming device;

FIG. 2 is a side sectional view of a warming cup; and

FIG. 3 is a side sectional view of a warming cup.

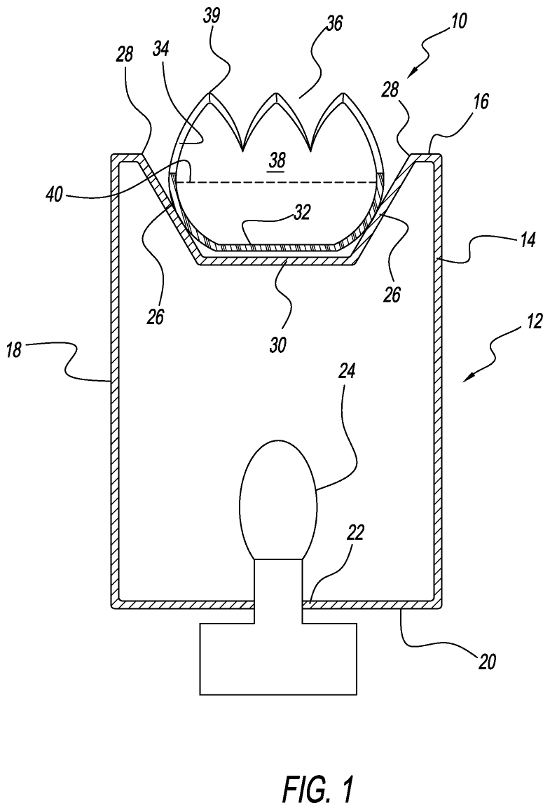

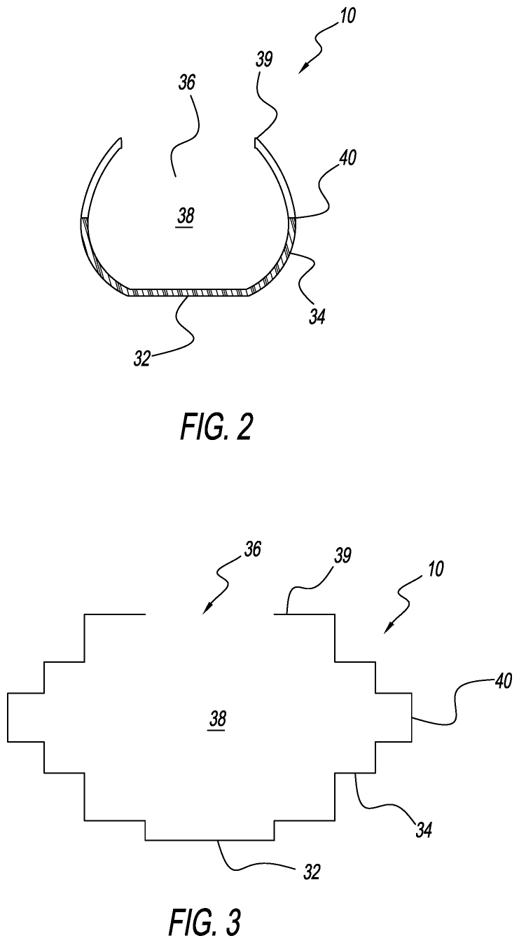

### DETAILED DESCRIPTION OF THE PREFERRED EMBODIMENTS

Referring to the Figures, a wax warming cup 10 is used in relation to a warming device 12. The warming device 12 is of any type and in the example shown the device 12 has a housing 14 with a top wall 16, a side wall 18 and a bottom wall 20. The bottom wall 20 has an opening 22 that receives a heat element 24 such as a light bulb or the like.

The top wall 16 has a shape adapted to receive the wax warming cup 10. While different shapes can be used, in the example shown the top wall 16 has an angled portion 26 that extends from a top edge 28 inwardly toward an inner base wall 30 that has a diameter less than a diameter of the top edge 28.

The wax warming cup 10 has a bottom wall 32, a side wall 34, and an open top 36 that form a chamber 38. Preferably, the bottom wall 32 is formed to fit within the top wall 16 of housing 14, have a diameter the same or slightly smaller than the diameter of the inner base wall 30, and at least partially engages the inner base wall 30.

The side wall 34 extends from the bottom wall 32 to a top edge 39. The side wall 34 extends upwardly and outwardly to a transition point 40. The transition point 40 is the horizontal plane on the wax warming cup having the largest diameter. The side wall 34 further extends from the transition point 40 upwardly and inwardly to the top edge 39. At least a portion, and preferably all of the top edge 39 has a diameter less than the diameter of the transition point 40. The shape of the side wall is of any type such as concave, arcuate, curved, angled, or even stepped with vertical and horizontal sections having different diameters. In the example shown the side wall 34 is arcuate having a concave outer surface with an uneven and jagged top edge 39. Because the diameter of the top edge 39 is at least partially less than the diameter at the transition point 40, the top edge 39 helps to contain the liquid hot wax within the chamber 38 particularly during transport.

Also important is that the wax warming cup 10 is made of a resilient material such as a food grade silicone. The material needs to be able to handle and transfer heat while remaining cool to the touch and be inert, have no off gassing and no scent. Finally, the material must be capable of being inverted to remove or pop-out wax that has cooled to a solid form. More particularly, one grasps the top edge 39 with their fingers and then presses the bottom wall 32 with their thumbs toward and past the top edge 39 releasing the cooled solid wax. The warming cup 10 can also be used with a small candle, or serve as a liner for glass, metal, or ceramic decorative candle holders that are otherwise difficult to clean.

Accordingly, a wax warming cup has been disclosed that, at the very least, meets all the stated objectives.

What is claimed is:

1. A wax warming cup, comprising:
a bottom wall;
a side wall that extends from the bottom wall to a top edge;
a transition point on the side wall where the side wall has its largest diameter; and
the top edge having at least a portion with a diameter less than the diameter of the transition point.

2. The cup of claim 1 wherein the cup is adapted to invert with manual force to remove cooled solid wax.

3. The cup of claim 1 wherein the cup is made of a resilient material adapted to handle and transfer heat while remaining cool to the touch.
